(19) United States
(12) Patent Application Publication
(10) Pub. No.: US 2003/0225992 A1
(43) Pub. Date: Dec. 4, 2003

(54) Method and system for compression of address tags in memory structures

(76) Inventors: Balakrishna Venkatrao, Santa Clara, CA (US); Krishna M. Thatipelli, Fremont, CA (US)

Correspondence Address: ZAGORIN O'BRIEN & GRAHAM LLP, 401 W 15TH STREET, SUITE 870, AUSTIN, TX, 78701, US

(21) Appl. No.: 10/156,965

(22) Filed: May 29, 2002

(51) Int. Cl. G06F 12/10; G06F 12/00

(52) U.S. Cl. 711/202; 711/108; 711/156

(57) ABSTRACT

A memory structure of a computer system receives an address tag associated with a computational value, generates a modified address which corresponds to the address tag using a compression function, and stores the modified address as being associated with the computational value. The address tag can be a physical address tag or a virtual address tag. The computational value (i.e., operand data or program instructions) may be stored in the memory structure as well, such as in a cache associated with a processing unit of the computer system. For such an implementation, the compressed address of a particular cache operation is compared to existing cache entries to determine which a cache miss or hit has occurred. In another exemplary embodiment, the memory structure is a memory disambiguation buffer associated with at least one processing unit of the computer system, and the compressed address is used to resolve load/store collisions. Compression may be accomplished using various encoding schemes, including complex schemes such as Huffinan encoding, or more elementary schemes such as differential encoding. The compression of the address tags in the memory structures allows for a smaller tag array in the memory structure, reducing the overall size of the device, and further reducing power consumption.

### BACKGROUND OF THE INVENTION

1. Field of the Invention

The present invention generally relates to computer systems and, more particularly, to a method of handling address tags used by memory structures of a computer system, such as system memory, caches, translation lookaside buffers, or memory disambiguation buffers.

2. Description of the Related Art

The basic structure of a conventional computer system 10 is shown in FIG. 1. Computer system 10 may have one or more processing units, two of which 12a and 12b are depicted, which are connected to various peripheral devices, including input/output (I/O) devices 14 (such as a display monitor, keyboard, and permanent storage device), memory device 16 (such as random access memory or RAM) that is used by the processing units to carry out program instructions, and firmware 18 whose primary purpose is to seek out and load an operating system from one of the peripherals (usually the permanent memory device) whenever the computer is first turned on. Processing units 12a and 12b communicate with the peripheral devices by various means, including a generalized interconnect or bus 20. Computer system 10 may have many additional components which are not shown, such as serial and parallel ports for connection to, e.g., modems or printers. Those skilled in the art will further appreciate that there are other components that might be used in conjunction with those shown in the block diagram of FIG. 1; for example, a display adapter might be used to control a video display monitor, a memory controller can be used to access memory 16, etc. Also, instead of connecting I/O devices 14 directly to bus 20, they may be connected to a secondary (I/O) bus which is further connected to an I/O bridge to bus 20. The computer can have more than two processing units.

In a symmetric multi-processor (SMP) computer, all of the processing units are generally identical, that is, they all use a common set or subset of instructions and protocols to operate, and generally have the same architecture. A typical architecture is shown in FIG. 1. A processing unit includes a processor core 22 having a plurality of registers and execution units, which carry out program instructions in order to operate the computer. The processing unit can also have one or more caches, such as an instruction cache 24 and a data cache 26, which are implemented using high-speed memory devices. Caches are commonly used to temporarily store values that might be repeatedly accessed by a processor, in order to speed up processing by avoiding the longer step of loading the values from memory 16. These caches are referred to as “on-board” when they are integrally packaged with the processor core on a single integrated chip 28. Each cache is associated with a cache controller (not shown) that manages the transfer of data between the processor core and the cache memory.

A processing unit 12 can include additional caches, such as cache 30, which is referred to as a level 2 (L2) cache since it supports the on-board (level 1) caches 24 and 26. In other words, cache 30 acts as an intermediary between memory 16 and the on-board caches, and can store a much larger amount of information (instructions and data) than the on-board caches can, but at a longer access penalty. For example, cache 30 may be a chip having a storage capacity of 512 kilobytes, while the processor may have on-board caches with 64 kilobytes of total storage. Cache 30 is connected to bus 20, and all loading of information from memory 16 into processor core 22 usually comes through cache 30. Although FIG. 1 depicts only a two-level cache hierarchy, multi-level cache hierarchies can be provided where there are many levels of interconnected caches.

A cache has many “blocks” which individually store the various instructions and data values. The blocks in any cache are divided into groups of blocks called “sets” or “congruence classes.” A set is the collection of cache blocks that a given memory block can reside in. For any given memory block, there is a unique set in the cache that the block can be mapped into, according to preset mapping functions which operate on an address tag of the cache line. The address tag corresponds to an address of the system memory device. The number of blocks in a set is referred to as the associativity of the cache, e.g. 2-way set associative means that for any given memory block there are two blocks in the cache that the memory block can be mapped into; however, several different blocks in main memory can be mapped to any given set. A 1-way set associate cache is direct mapped, that is, there is only one cache block that can contain a particular memory block. A cache is said to be fully associative if a memory block can occupy any cache block, i.e., there is one congruence class, and the address tag for the cache line is usually the full address of the memory block.

An exemplary cache line (block) includes an address tag field, a state bit field, an inclusivity bit field, and a value field for storing the actual instruction or data. The state bit field and inclusivity bit fields are used to maintain cache coherency in a multiprocessor computer system (i.e., indicate the validity of the value stored in the cache).

FIG. 2 illustrates that the address tag is usually a subset of the full address of the corresponding memory block in the main system memory device. Virtual and physical memory addresses can be conceptualized as being divided into three units: an address tag 200, an index 210, and a block offset 220. The address tag 200 is the portion of the address that is cached in the tag array structure. The index 210 is used by the cache to manage and access cache entries within the cache. The block offset 220 is used by the cache to access a specific datum from within the memory block being accessed. A compare match of an incoming address with one of the tags within the address tag field 200 indicates a cache “hit.” The collection of all of the address tags in a cache (and sometimes the state bit and inclusivity bit fields) is referred to as a directory, and the collection of all of the value fields is the cache entry array.

On-board caches are increasingly occupying a large percentage of the processor chip area. They now contribute significantly to the processor area and power requirements. An increase in cache area results in lower yields, while an increase in power consumption requires sophisticated cooling techniques to retain performance and reliability. Both of these problems significantly affect the cost factor for processing units. These problems occur not just with caches, but also with many other structures that require address tags. For example, many processors include other structures that contain the address tags as well. Examples of such other structures include memory disambiguation buffers, translation lookaside buffers, and store buffers. Store buffers hold operand data and program instructions, and include the address tags.

Memory disambiguation buffers are used to perform bypass in situations where data dependencies occur in system that allows speculative and out-of-order which are used to resolve potential problems in deciphering the address tags, also store tag information. Superscalar computers are designed to optimize program performance by allowing load operations to occur out of order. Memory dependencies are handled by superscalar machines on the assumption that data be loaded is often independent of store operations. These processors maintain an address comparison buffer to determine if there is any potential memory dependency problem, or “collision.” All of the store operation physical addresses are saved in this buffer, and load operations are allowed to occur out of order. At completion time, the address for each load operation is checked against the contents of the memory disambiguation buffer for any older store operations with the same address (collisions). If there are no collisions, the instructions (both loads and stores) are allowed to complete. If there is a collision, the load instructions have received stale data and, hence, have to be refreshed. Since the corrupted load data may have been used by a dependent instruction, all instructions previous to the load instruction must be restarted, with a resulting degradation in performance. Memory dependencies can be true or false if the mapping scheme creates ambiguities. A memory dependency is false if evaluation of the memory location for a load operation appears to be the same as that for the memory location of a prior store operation, but in actuality is not the same because the aliases point to different physical memory locations.

Additionally, there are various devices that are used to convert virtual memory addresses into physical memory addresses, such as a translation lookaside buffer. In a typical computer system, at least a portion of the virtual address space is partitioned into a number of memory pages, which each have at least one associated operating system-created address descriptor, called a page table entry (PTE). A PTE corresponding to a virtual memory page typically contains the virtual address of the memory page, the associated physical address of the page frame in main memory, and statistical fields indicating if the memory page has been referenced or modified. By reference to a PTE, a processor is able to translate a virtual (effective) address within a memory page into a physical (real) address. PTE's are typically stored in RAM in groups called page tables. Because accessing PTE's in RAM to perform each address translation would greatly diminish system performance, each processor in a conventional computer system is also typically equipped with a translation lookaside buffer (TLB) that caches the PTEs most recently used by that processor to enable quick access to that information.

Many of the foregoing structures utilize content-addressable memory (CAM) in order to improve performance. CAM is a memory structure which can search for stored data that matches reference data, and read information associated with matching data, such as an address indicating a location in which the matching data is stored. Match results are reflected on match lines that are provided to a priority encoder that translates the matched location into a match address or CAM index for output from the CAM device. Each row of CAM cells is typically connected to a word line as in conventional static random-access memory (SRAM) and at least one match line, and it is necessary to precharge the word lines prior to any search and read operation. CAMs are thus particularly power-hungry structures, which can exacerbate the foregoing problems.

In light of the foregoing, it would be desirable to devise an improved memory structure for a computer system, which required less chip area, and reduced power requirements. It would be further advantageous if the improved memory structure could more efficiently handle values having address tags or other associated location data.

### SUMMARY OF THE INVENTION

In one aspect, the present invention describes a method of storing address information in a memory structure. The method includes generating a modified address for a first address tag using at least one compression function, storing the modified address in the memory structure. According to an embodiment of the present invention, the compression function is Huffman encoding function. According to an embodiment of the present invention, the compression function is differential encoding function. In one embodiment, the first address tag is a virtual address tag, and the modified address is a virtual address. In one embodiment, the virtual address tag corresponds to a physical memory address.

The method further includes receiving the first address tag. The method further includes using the modified address to access a memory unit in the memory structure. In one embodiment, the memory structure is a cache. The method further includes comparing the modified address with an address of a cache operation. In one embodiment, the memory structure is a memory disambiguation buffer. The method further includes resolving a load/store collision using the modified address. In one embodiment, the generating the modified address further includes loading a base value into a register, and comparing the first address tag with the base value.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a conventional computer system having various memory structures, including a system memory device and multiple caches;

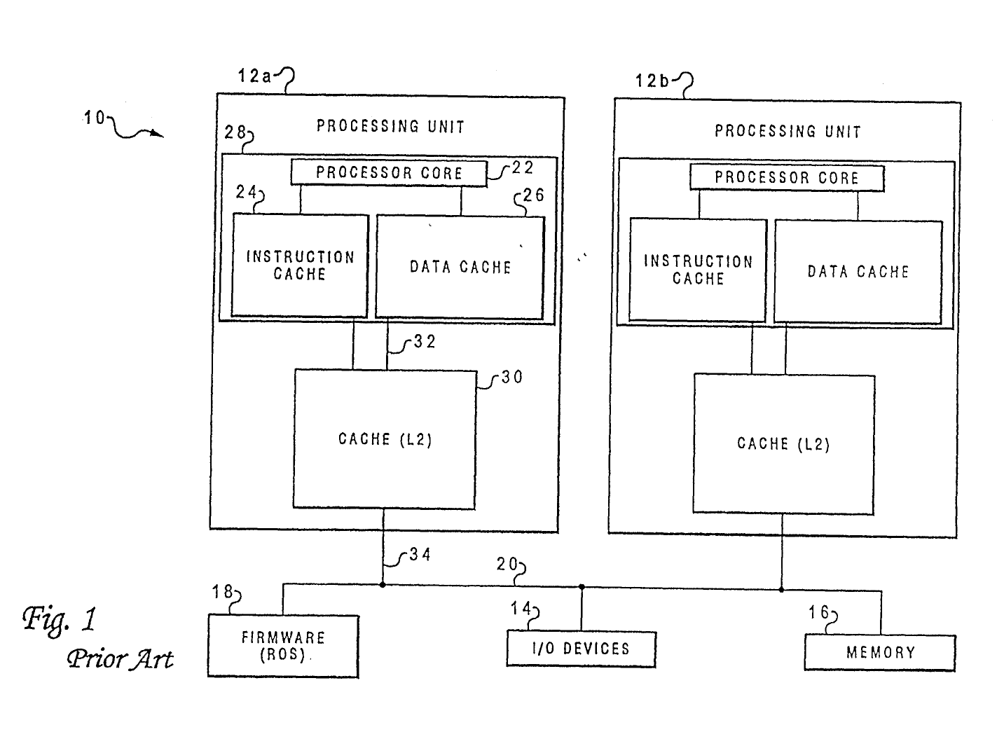

FIG. 2 is a block diagram of a memory address.

FIG. 3 is a pictorial representation of a method and device according to the present invention, by which a plurality of address aliases are generated corresponding to memory addresses in a procedure, the aliases are used to access physical memory locations, and a memory disambiguation buffer is used to resolve potential load/store collisions;

FIG. 4 is a pictorial representation of the address tag compression performed by the memory disambiguation buffer of FIG. 3; and

FIG. 5 is a chart illustrating the logical flow for an exemplary implementation of the present invention.

The use of the same reference symbols in different drawings indicates similar or identical items.

### DESCRIPTION OF THE PREFERRED EMBODIMENT(S)

The present invention is directed to a method and system for compressing address tags in memory structures of a computer. By compressing the address tags, fewer bits are required for storage, and for searching or hit/miss comparison. The memory structures can thus be reduced in size, and operate with less power.

One exemplary memory structure in which the invention may be embodied is a cache. As explained in the Background section, caches generally have two arrays: the actual values or cache entries, and the address tags or directory. For a 64-kilobyte (KB), direct-mapped data cache that is virtually indexed and virtually tagged, which uses 32-bit virtual addressing, and a block size of four bytes, the total size of a typical prior art cache is 98 KB, including the cache directory (and validity bits). The tags occupy 34 KB, or about 50% of the size of the cache entry array. Though this percentage may be reduced with larger block sizes, it nevertheless constitutes a significant portion of the overall cache. Typically, it is not necessary to consider the full number of tag bits for most memory structures. The present invention thus imparts a considerable advantage in the construction of the memory structure, by reducing the size required for the address information.

The redundancy in address traces translates directly to redundancy in tags, since they are a subset of the memory addresses. Accordingly, compression may be used to store the tags in the various structures, and realize a reduction in the number of bits required, without sacrificing performance. The compression scheme can be as simple as, e.g., differential encoding where only the difference between consecutive tags are stored, rather than using the complete tags, or a more complex scheme such as Huffman encoding, etc. While the memory structure will require additional chip area and power for the compression logic, the reduced number of bits will more than compensate, with overall area savings and power savings, contributing directly to performance improvement and cost reduction.

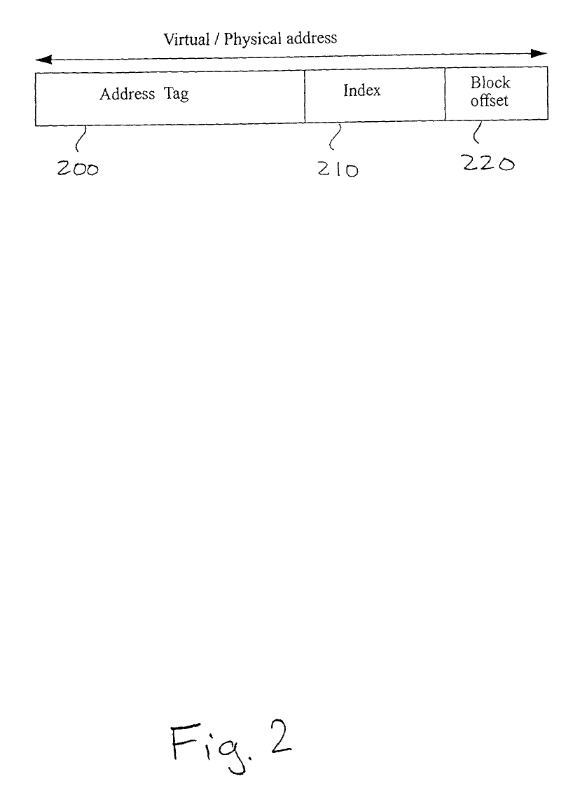

There are many other structures in a computer system which store address or tag information, such as store buffers, translation lookaside buffers (TLBs), and memory disambiguation buffers. FIG. 2 illustrates one implementation of the invention for a memory disambiguation buffer.

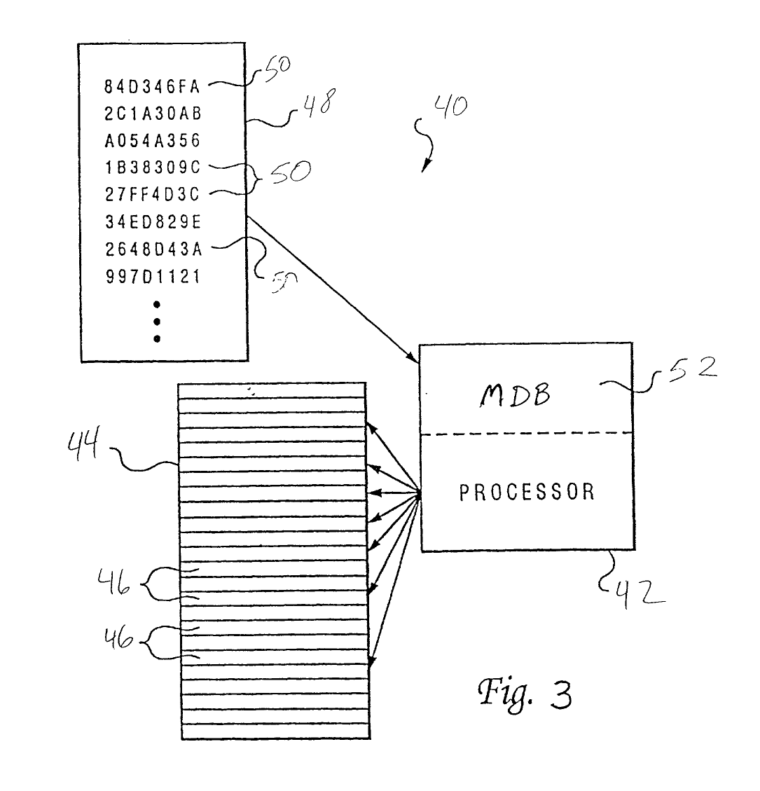

As seen in FIG. 3, computer system 40 is generally comprised of a processor 42 and a memory array 44 having a plurality of physical memory locations 46 which are accessed by processor 42. Processor 42 executes a procedure 48 associated with a computer program, which includes a plurality of program instructions and data values with corresponding memory addresses 50 (in the exemplary embodiment of FIG. 2, addresses 50 are 32-bit values expressed by eight hexadecimal digits). Addresses 50 are mapped to physical memory locations 46 by processor 42, such that computed values can be stored from the processor's registers into physical memory locations 46, and values from those locations can be loaded in the processor's registers.

A memory disambiguation buffer (MDB) 52 uses the address information to perform comparisons for load/store collisions, similar to the manner that conventional store buffers perform address comparisons. However, as explained below, the comparisons are performed on smaller-sized (compressed) addresses, so the memory dependency check is faster.

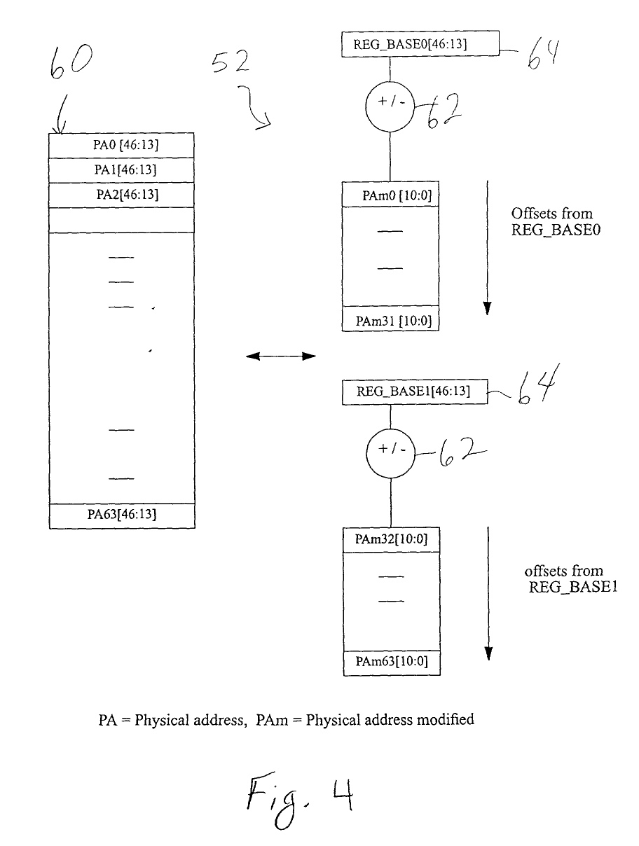

As further shown in FIG. 4, a physical address (PA) array 60 is used to store the physical address bits PA[46:13] of the memory instructions 48 (loads and stores), which are used for fall address comparison. This comparison is required to establish the correctness of the data bypassed to load on a RAW (Read after Write) hit, since the bypass is done based on the comparison of the virtual address bits VADD[12:0]. Performance analysis has shown that using VADD[12:0] provides a good prediction rate for bypassing. In the event that the physical address comparison is rendered incorrect, it establishes that the prediction was wrong, and that the load instruction and its dependent instructions should be replayed. However, it can be seen that the physical address array 60 occupies a sizeable area of the MDB. Because it is desirable to use a content-addressable memory (CAM) for array 60, it further consumes a lot of power in reading and writing into the array.

The present invention allows for optimization to reduce the area occupied by the physical address array. One optimization technique is to use a compression function. Compression is feasible since it is likely the PA[46: 13] array is redundant in nature. That is to say, the entries in the physical address array are likely to be close in range. This follows from typical program behavior according to which the program often spends 90% of its time in 10% of the code. This behavior results in program addresses of the loads and stores to be very close to each other.

One of the compression techniques is differential coding, where only the difference with respect to a base value is stored in the physical address array. Any incoming address is compared with a base value, and only the difference is stored. For full physical address comparison, this difference is added back to the base value to get the full address. By this method, it becomes necessary to store only the differences in the physical address array, which is likely to be on the order of 10 bits. In the present example, this approach translates to an immediate saving of 23 bits per physical address array entry (x 64), significantly reducing the physical address array size. The lower number of bits also translates to power savings. The invention imposes nominal circuit requirements, of adders and subtractors 62, and a base register 64 to hold the base value.

In the diagram of FIG. 4, the PAm modified physical addresses are shown as offsets from the base register. They can, however, be more complex functions of the base registers. Other encoding schemes, known in the art, can be used as well that are not dependent on the use of a base register.

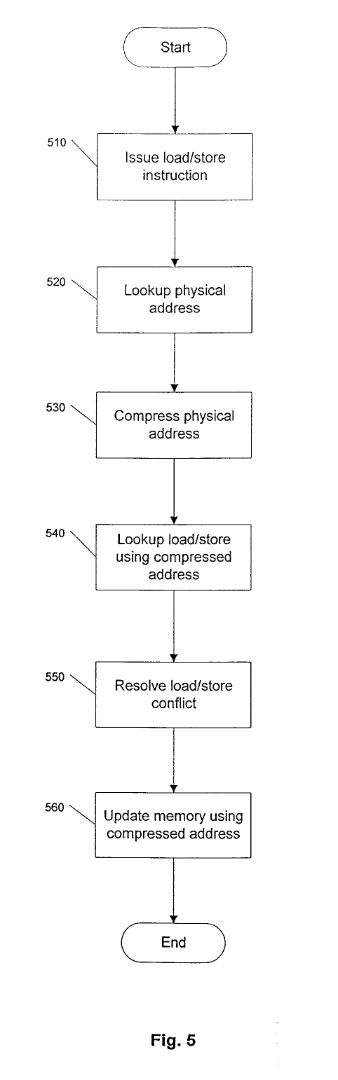

FIG. 5 illustrates an example of steps performed for storing information using compressed address tags according to an embodiment of the present invention. Initially, an instruction scheduler issues load/store instruction (step 510). The system then looks up the physical address for the logical address of the instruction (e.g., using translation look aside buffer or the like) (step 520). The system compresses the physical address using one or more of compression techniques (e.g., Huffman encoding, differential encoding or the like). Next, the system looks up load/store instructions using the compressed address (step 540). In an out of order processor, a load instruction from a memory location can be issued before the data is stored in that location. This can create a load/store conflict. The memory disambiguation buffer resolves these load/store conflicts using the compressed address (step 550). The system then updates memory blocks using compressed addresses (step 560).

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A method of storing address information in a memory structure comprising:
generating a modified address for a first address tag using at least one compression function;
storing said modified address in said memory structure.

2. The method of claim 1, wherein said compression function is Huffman encoding function.

3. The method of claim 1, wherein said compression function is differential encoding function.

4. The method of claim 1, wherein said first address tag is a virtual address tag; and
said modified address is a virtual address.

5. The method of claim 4, wherein said virtual address tag corresponds to a physical memory address.

6. The method of claim 1, further comprising:
receiving said first address tag.

7. The method of claim 1, further comprising:
using said modified address to access a memory unit in said memory structure.

8. The method of claim 1 wherein said memory structure is a cache.

9. The method of claim 8, further comprising:
comparing said modified address wit h a n address o f a cache operation .

10. The method of claim 1, wherein said memory structure is a memory disambiguation buffer.

11. The method of claim 10, further comprising:
resolving a load/store collision using said modified address.

12. The method of claim 3, wherein said generating said modified address further comprising:
loading a base value into a register; and
comparing said first address tag with said base value.

13. A memory structure comprising:
at least one memory array which receives an address tag associated with a computational value; and
an encoder which generates a modified address corresponding to the address tag, using a compression function, the modified address being stored in the memory array, associated with the computational value.

14. The electronic memory structure of claim 13 wherein:
the address tag is a virtual address tag which corresponds to a physical memory address; and
the modified address is a modified virtual address.

15. The electronic memory structure of claim 13 wherein said memory array is a content-addressable memory.

16. The electronic memory structure of claim 13 wherein said encoder is a Huffman encoder.

17. The electronic memory structure of claim 13 wherein said encoder is a differential encoder.

18. A computer system comprising:
one or more processing units for carrying out program instructions;
a memory hierarchy storing computational values, including program instructions and operand data, wherein the computational values are associated with unique physical addresses;
an interconnect between said one or more processing units and said memory hierarchy; and
encoding logic which generates a modified address for a given computational value using a compression function.

19. The computer system of claim 18 wherein the encoding logic operates on a virtual address which corresponds to a physical address associated with the given computational value.

20. A system of storing address information in a memory structure comprising:
means for generating a modified address for a first address tag using at least one compression function;
means for storing said modified address in said memory structure.

21. The system of claim 20, wherein said compression function is Huffman encoding function.

22. The system of claim 20, wherein said compression function is differential encoding function.

23. The system of claim 20, wherein said first address tag is a virtual address tag; and
said modified address is a virtual address.

24. The system of claim 23, wherein said virtual address tag corresponds to a physical memory address.

25. The system of claim 20, further comprising:
mean for receiving said first address tag.

26. The system of claim 20, further comprising:
means for using said modified address to access a memory unit in said memory structure.

27. The system of claim 20 wherein said memory structure is a cache.

28. The system of claim 27, further comprising:
means for comparing said modified address with an address of a cache operation.

29. The system of claim 20, wherein said memory structure is a memory disambiguation buffer.

30. The system of claim 29, further comprising:
means for resolving a load/store collision using said modified address.

31. The system of claim 22, wherein said generating said modified address further comprising:
means for loading a base value into a register; and
means for comparing said first address tag with said base value.

32. A computer program product for storing address information in a memory structure, encoded in computer readable media, the program product comprising a set of instructions executable on a computer system, the set of instructions is configured to
generate a modified address for a first address tag using at least one compression function;
store said modified address in said memory structure.

33. The computer program product of claim 32, wherein said compression function is Huffman encoding function.

34. The computer program product of claim 32, wherein said compression function is differential encoding function.

35. The computer program product of claim 32, wherein said first address tag is a virtual address tag; and
said modified address is a virtual address.

36. The computer program product of claim 35, wherein said virtual address tag corresponds to a physical memory address.

37. The computer program product of claim 32, wherein said set of instructions is further configured to receive said first address tag.

38. The computer program product of claim 32, wherein said set of instructions is further configured to use said modified address to access a memory unit in said memory structure.

39. The computer program product of claim 32 wherein said memory structure is a cache.

40. The computer program product of claim 39, wherein said set of instructions is further configured to compare said modified address with an address of a cache operation.

41. The computer program product of claim 32, wherein said memory structure is a memory disambiguation buffer.

42. The computer program product of claim 41, wherein said set of instructions is further configured to resolve a load/store collision using said modified address.

43. The computer program product of claim 34, wherein said generating said modified address wherein said set of instructions is further configured to
load a base value into a register; and
compare said first address tag with said base value.
